(19) United States
(12) Patent Application Publication
(10) Pub. No.: US 2012/0192212 A1
(43) Pub. Date: Jul. 26, 2012

(54) OPTICAL DISK PLAYER

(75) Inventors: JI-FENG QIU, Shenzhen City (CN); XUE-DONG TANG, Shenzhen City (CN); PING LI, Shenzhen City (CN); XIAO-HUI ZHOU, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/105,948

(22) Filed: May 12, 2011

(30) Foreign Application Priority Data
Jan. 20, 2011 (CN) 201110022774.0

(51) Int. Cl. G11B 17/051

(52) U.S. Cl. 720/655; G9B/17.032

(57) ABSTRACT

An optical disk player includes a main body, a disk tray, and a cover. The main body includes a top surface with a receiving recess defined thereon. The disk tray is received in the receiving recess for reading data written on an optical disk. The cover is configured for covering the receiving recess of the main body. A ring-shaped groove is formed on the top surface of the main body surrounding the receiving recess, and a protrusion is formed on an inner surface of the cover facing the main body, the protrusion is capable of being inserted into the groove when the cover is closed on the top surface of the main body.

### BACKGROUND

1. Technical Field

The present disclosure relates to optical disk players, particularly, to a dustproof optical disk player.

2. Description of Related Art

Optical disk players, such as DVD (digital versatile disk) players etc., are widely used. A typical optical disk player includes a disk tray for receiving an optical disk and an optical pickup for reading the data of the optical disk. However, both of the optical disk and the optical pickup should be dust free for optimal performance If dust gathers or accumulates on the lens of the optical pickup, the performance of the optical disk will be degraded.

What is needed, therefore, is a dustproof optical disk player which can ameliorate the problem described above.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a schematic, isometric view of an optical disk player with a cover of a disk tray thereof opened according to an exemplary embodiment.

FIG. 2 is a schematic, isometric view of an optical disk player of FIG. 1 with an optical disk placed therein.

FIG. 3 is a schematic, isometric view of an optical disk player of FIG. 1 with the cover of the disk tray thereof closed.

FIG. 4 is a magnified cross-sectional cut-away view of the optical disk player taken along line IV-IV of FIG. 3.

FIG. 5 is a magnified cross-sectional cut-away view of the optical disk player taken along line IV-IV of FIG. 3 according to an another exemplary embodiment.

### DETAILED DESCRIPTION

Embodiments of the present disclosure will now be described in detail below, with reference to the accompanying drawings.

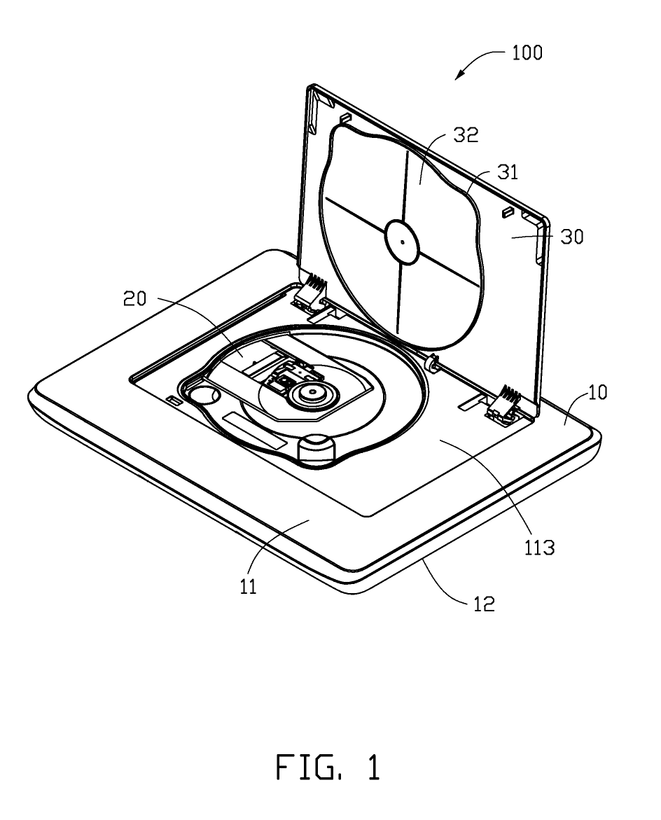

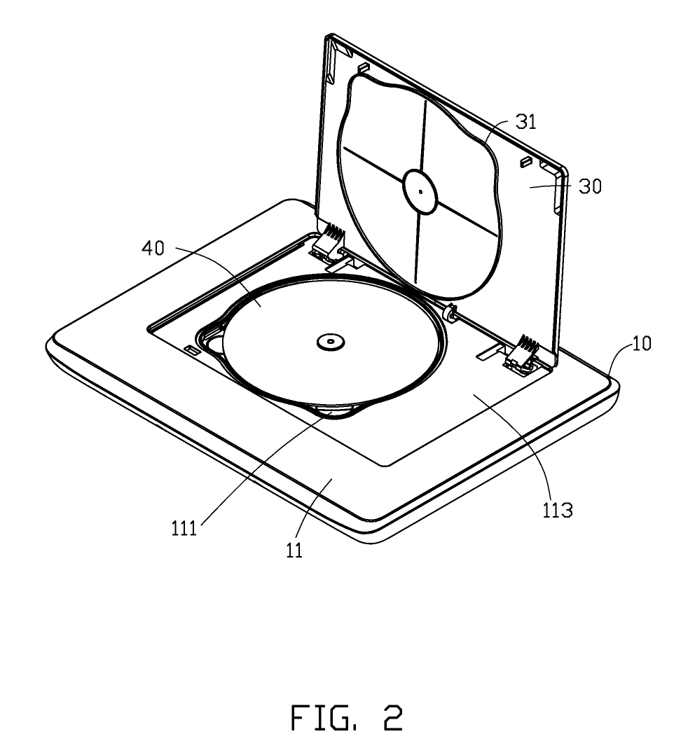

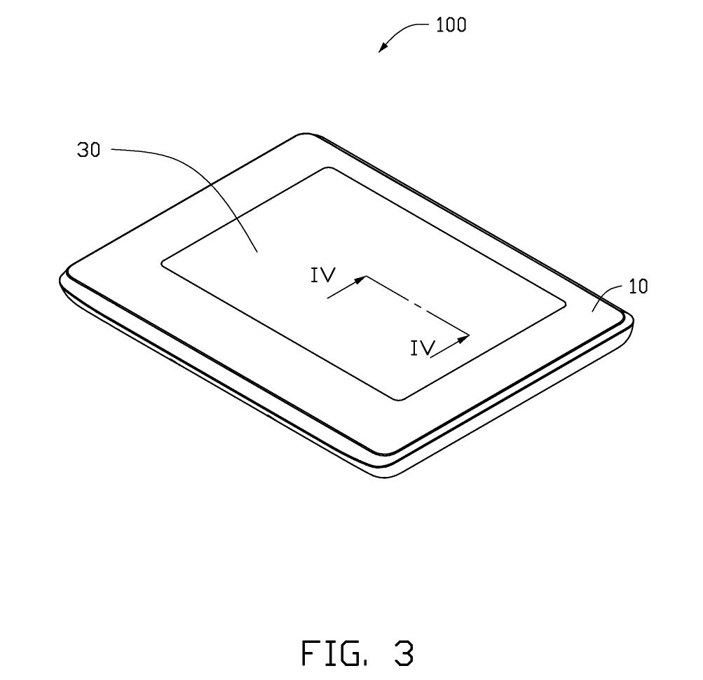

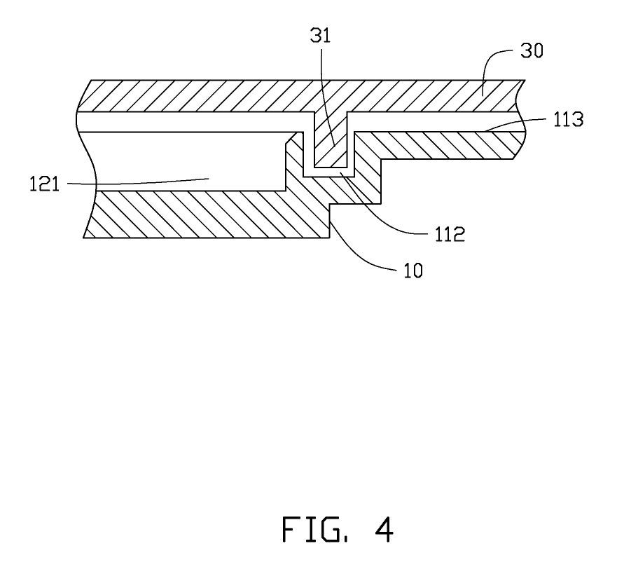

Referring to FIGS. 1 to 4, an optical disk player 100 according to an exemplary embodiment is shown. The optical disk player 100 includes a main body 10, a disk tray 20, and a cover 30. The optical disk player 100 can be a DVD player, a CD (compact disk) player, a VCD (video compact disk) player etc. In the present embodiment, the optical disk player 100 is a DVD player.

The main body 10 includes a top surface 11 and a bottom surface 12 opposite to the top surface 11. The main body 10 defines a receiving recess 111 on the top surface 11 thereof, and defines a ring-shaped groove 112 surrounding the receiving groove 111 on the top surface 11. The receiving recess 111 can be circular, rectangular-shaped etc. In the present embodiment, the receiving recess 111 is substantially circular.

The disk tray 20 is received in the receiving recess 111 for reading data written on an optical disk 40. Preferably, the size of the receiving recess 111 is larger than that of the optical disk 40, thus, the optical disk 40 can be inserted into or taken out of the disk tray 20 conveniently.

The cover 30 is configured for covering the receiving recess 111 of the main body 10. The cover 30 can be slidable or pivotably connected to the main body 10. The cover 30 can also be an independent element separated from the main body 10. In the present embodiment, the cover 30 is pivotably connected to the main body 10. The cover 30 includes a ring-shaped protrusion 31 on an inner surface thereof facing the main body 10. The protrusion 31 can be inserted into the groove 112 when the cover 30 is closed, thus, foreign substances, such as dusts, water etc., out of the optical disk player 100 is difficult to introduce into the receiving recess 111 to deteriorate the performance of the disk tray 20. Preferably, the protrusion 31 is in tight contact with an inner wall of the groove 112.

In the present embodiment, the cover 30 includes a transparent portion 32 spatially corresponding to the receiving recess 111 of the main body 10. From the transparent portion 32, users can see the working state of the disk tray 20 conveniently.

In order that the optical disk player 100 has good appearance, the top surface 11 of the main body 10 can further have a low-lying area 113 for placing the cover 30 when the cover 30 is closed. An outer surface of the cover 30 facing away from the main body 10 is at the same level as that of the top surface 11 of the main body when the cover 30 is attached to the low-lying area 113. In the present embodiment, the groove 112 is defined in the low-lying area 113 of the top surface 11.

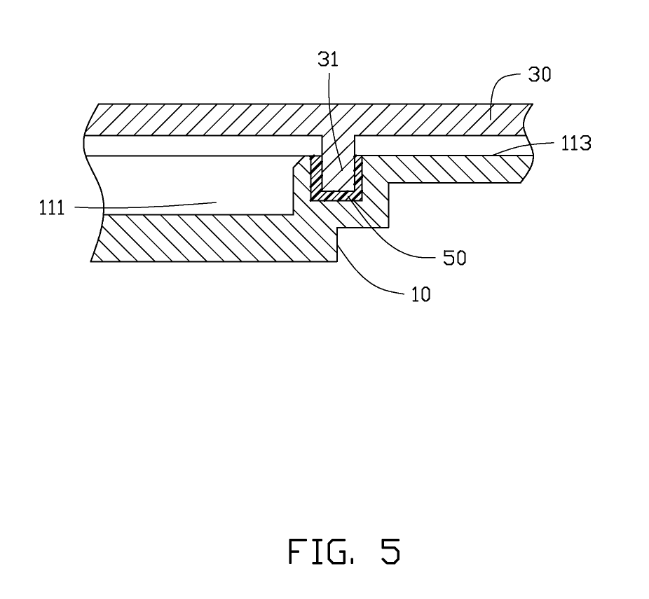

It is understood, in other embodiment, the protrusion 31 can also be formed on the top surface 11 of the main body 10, and the groove 112 can be defined on the inner surface of the cover 30. Referring to FIG. 5, in some embodiments, the groove 112 can also include a soft filler 50 received therein, the soft filler 50 can improve sealing property of the receiving recess 111. The soft filler 50 can be made of sponge, etc.

While certain embodiments have been described and exemplified above, various other embodiments will be apparent to those skilled in the art from the foregoing disclosure. The disclosure is not limited to be particular embodiments described and exemplified, and the embodiments are capable of considerable variation and modification without departure from the scope and spirit of the appended claims.

What is claimed is:

1. An optical disk player comprising:
a main body comprising a top surface with a receiving recess defined thereon;
a disk tray received in the receiving recess for reading data written on an optical disk; and
a cover for covering the receiving recess of the main body,
wherein either of a ring-shaped protrusion and a ring-shaped groove is formed on the top surface of the main body surrounding the receiving recess, and the other one of the ring-shaped protrusion and the ring-shaped groove is formed on an inner surface of the cover facing the main body, the protrusion is capable of being inserted into the groove when the cover is closed on the top surface of the main body to cover the receiving recess of the main body.

2. The optical disk player as claimed in claim 1, wherein the optical disk player is a DVD player, a CD player, or a VCD player.

3. The optical disk player as claimed in claim 1, wherein the receiving recess is circular.

4. The optical disk player as claimed in claim 1, wherein the cover is pivotably connected to the main body.

5. The optical disk player as claimed in claim 1, wherein the protrusion is in tight contact with an inner wall of the groove.

6. The optical disk player as claimed in claim 1, wherein the cover comprises a transparent portion spatially corresponding to the receiving recess of the main body.

7. The optical disk player as claimed in claim 1, wherein the top surface of the main body has a low-lying area for placing the cover when the cover is closed, and an outer surface of the cover facing away from the main body is at the same level as that of the top surface of the main body when the cover is attached to the low-lying area.

8. The optical disk player as claimed in claim 1, wherein the optical disk player further comprises a soft filler received in the groove for improving sealing property of the receiving recess.

9. The optical disk player of claim 8, wherein the soft filler is made of sponge.

10. The optical disk player of claim 1, wherein the ring-shaped groove is defined on the top surface of the main body surrounding the receiving recess, and the ring-shaped protrusion is formed on the inner surface of the cover.
